(19) United States
(12) Patent Application Publication
(10) Pub. No.: US 2009/0033170 A1
(43) Pub. Date: Feb. 5, 2009

(54) Rotor Of An Asynchronous Machine

(75) Inventors: Martin Jakobi, Schwelm (DE); Helmut Sopp, Fladungen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 11/994,018

(22) PCT Filed: Jun. 26, 2006
(86) PCT No.: PCT/EP2006/063532

§ 371 Date: Jul. 18, 2008

(30) Foreign Application Priority Data
Jun. 29, 2005 (DE) 10 2005 030 798.1

(51) Int. Cl. H02K 17/16; H02K 15/02

(52) U.S. Cl. 310/156.79; 29/598; 310/267

(57) ABSTRACT

The invention relates to a rotor of an asynchronous machine with grooves (7) for accommodating short circuit rods on the ends of the laminated core (1), the respective ends of the short circuit rods being connected by an end ring (3) and additional profiled sheets (2) being provided in the region of the end rings (3) for laminating of the laminated core (1) and for absorbing the centrifugal forces of the end rings (3). Comparatively high speeds can thus be achieved.

The invention relates to a rotor of an asynchronous machine for high rotation speeds.

In order to increase the mechanical rotation speed limits of the rotors of asynchronous machines which are predetermined by the strength values of aluminum or copper, the short-circuiting rings are specially reinforced in order to reach tip speeds of up to more than 150 m/s. For this purpose, the rotor needs to be machined, and a special ring for absorbing the centrifugal forces needs to be fitted separately.

Such a design is known from DE 195 21 700 A1. Here, the short-circuiting ring, which is spaced apart from the laminate stack, is provided with a shrink ring, inter alia.

DE 199 27 279 A1 has disclosed interference fits for a short-circuiting ring, which is spaced apart from a laminate stack, which are intended to absorb the centrifugal forces of the short-circuiting ring.

These measures are extremely complex to implement in design terms and correspondingly the rotor can only be manufactured in a complex manner.

Against this background, the invention is based on the object of providing a rotor which withstands tip speeds of up to more than 150 m/s in a simple manner and can be fitted or manufactured easily.

The set object is achieved by a rotor of an asynchronous machine with profiled metal sheets on the end sides of its laminate stack, which has slots for accommodating short-circuiting bars, the short-circuiting bars being connected on the respective end sides by a short-circuiting ring, and additional profiled metal sheets being provided in the region of the short-circuiting rings and being used for stacking the laminate stack and absorbing the centrifugal forces of the short-circuiting ring.

The set object is achieved also by a method for manufacturing a rotor for an asynchronous machine as claimed in claim 1, characterized by the following steps:
stacking of a laminate stack in such a way that substantially axially running slots are provided,
positioning of profiled metal sheets on the end sides of the laminate stack,
insertion of the laminate stack with the profiled metal sheets into a suitable apparatus,
slots are provided with short-circuiting bars,
short-circuiting rings are provided on the end sides of the laminate stack having the profiled metal sheets.

By introducing the profiled metal sheet(s), the centrifugal force limit of the squirrel-cage winding formed by the short-circuiting bars and the short-circuiting rings is substantially increased in the rotor by the brace effect.

Advantageously, these profiled metal sheets are produced from a high-strength and highly conductive metal sheet. The profiled metal sheet has at least openings in the region of the shaft passage and slots. In this case, the geometric dimensions at least correspond to the dimensions provided in the laminate stack for slots and shaft passage. Advantageously, in this case the dimensions of the profiled metal sheets are slightly larger.

Advantageously, the profiled metal sheets are fixed on the laminate stack by the short-circuiting ring on each end side. The short-circuiting ring therefore bears directly against the profiled metal sheet; no spacers are provided.

The short-circuiting bars can be soldered directly to the short-circuiting ring. In an advantageous configuration, the entire squirrel-cage winding is formed and at the same time the profiled metal sheets are fixed by means of an aluminum or copper diecasting process.

The invention and further advantageous configurations of the invention will be explained in more detail with reference to a schematically illustrated exemplary embodiment. In the drawing:

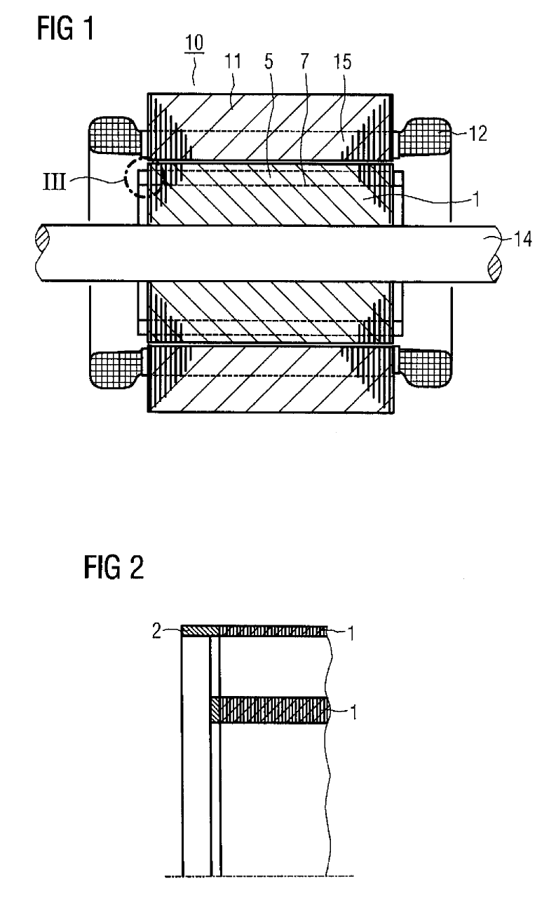

FIG. 1 shows a basic illustration of an asynchronous machine with a squirrel-cage rotor,

FIG. 2 shows a partial longitudinal section through a rotor without a squirrel-cage winding,

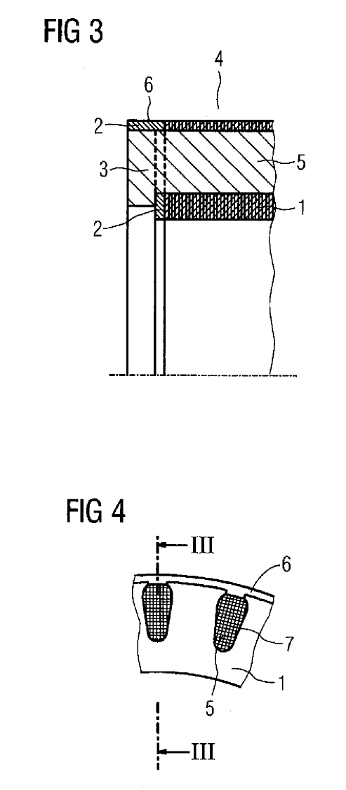

FIG. 3 shows a partial longitudinal section through a rotor with a squirrel-cage winding, and

FIG. 4 shows a partial cross section through the rotor with a squirrel-cage winding.

FIG. 1 shows an asynchronous machine 10 with a squirrel-cage rotor as a basic illustration. A stator 11 has slots 15, in which a winding system is located which forms end windings 12 on the end sides of the stator 11. The rotor has slots 7, in which conductors 5 are located, which conductors 5 are connected on the end sides of the rotor in each case by means of one short-circuiting ring 3. The rotor forms a laminate stack 1, profiled metal sheets being located on the end sides of the rotor, which profiled metal sheets are illustrated and explained in more detail in the further figures. The rotor is connected to, for example shrunk onto, a shaft 14 in a manner in which it is fixed against rotation.

The rotor can also be constructed of sintered material, as an alternative to this.

FIG. 2 shows a laminate stack 1 comprising stacked, preferably by means of stamping, individual laminates (not illustrated in any more detail), a profiled metal sheet 2 adjoining the end sides thereof, which profiled metal sheet 2 largely corresponds in terms of its cross section to the slots 7 provided in the laminate stack 1.

FIG. 3 shows a partial longitudinal section through a diecast rotor 4, whose laminate stack 1 has been provided with an electrical conductor 5, which lies in axially running slots 7 of the laminate stack 1. The conductor bars, which protrude axially out of the slots, form a short-circuiting ring 3, which runs in the circumferential direction, on the end sides of the laminate stack 1. In order to be able to absorb the centrifugal forces, in particular of the short-circuiting ring 3 in the event of high tip speeds of greater than 150 m/s, the profiled metal sheet 2 is designed in such a way that it represents, as an axial extension of the laminate stack 1, a web 6, which absorbs the centrifugal forces. The profiled metal sheet 2 is advantageously made from a high-strength and highly conductive material.

FIG. 4 shows, in a partial cross section, the laminate stack 1 with the conductors 5, which lie in slots 7 and are short-circuited in the form of a short-circuiting ring on the end sides of the laminate stack 1.

1.-9. (canceled)

10. A rotor of an asynchronous machine, comprising:
a laminate stack having slots;
short-circuiting bars accommodated in the slots and having opposite ends;
short-circuiting rings connecting the ends of the short-circuiting bars; and
profiled metal sheets provided in a region of the short-circuiting rings and used for stacking the laminate stack and absorbing centrifugal forces of the short-circuiting rings.

11. The rotor of claim 10, wherein the profiled metal sheets cover at least an axial part of the short-circuiting rings.

12. The rotor of claim 10, wherein the slots have a skewed configuration.

13. The rotor of claim 10, wherein the slots have a closed configuration.

14. The rotor of claim 10, wherein the slots have a half open configuration.

15. A method for manufacturing a rotor for an asynchronous machine, comprising the steps of:
stacking a laminate stack to provide substantially axially extending slots;
positioning profiled metal sheets on an end sides of the laminate stack;
inserting the laminate stack with the profiled metal sheets into a suitable device;
providing short-circuiting bars with slots; and
attaching short-circuiting rings onto the end sides of the laminate stack having the profiled metal sheets.

16. The method of claim 15, further comprising the step of producing the short-circuiting rings and the short-circuiting bars by a diecasting process.

17. The method of claim 16, wherein the diecasting process is carried out using aluminum or copper.

18. The method of claim 16, further comprising the step of pretreating the profiled metal sheets with flux before the diecasting process.

19. The method of claim 15, further comprising the step of joining prefabricated short-circuiting bars and short-circuiting rings by a soldering process.
